(19) United States
(12) Patent Application Publication
(10) Pub. No.: US 2010/0070506 A1
(43) Pub. Date: Mar. 18, 2010

(54) Query Expansion Method Using Augmented Terms for Improving Precision Without Degrading Recall

(75) Inventors: Kyu-Young Whang, Daejon (KR); Yi Reun Kim, Gwangju (KR); Jun Seok Heo, Seoul (KR); Jung Hoon Lee, Daejon (KR); Tuan Quang Nguyen, Daejon (KR)

Correspondence Address: BOND, SCHOENECK & KING, PLLC, 10 BROWN ROAD, SUITE 201, ITHACA, NY, 14850-1248, US

(73) Assignee: Korea Advanced Institute of Science and Technology, Daejon (KR)

(21) Appl. No.: 12/401,014

(22) Filed: Mar. 10, 2009

(30) Foreign Application Priority Data
Mar. 18, 2008 (KR) 10-2008-0024776

(51) Int. Cl. G06F 17/30

(52) U.S. Cl. 707/740; 707/765; 707/E17.074; 707/E17.046

(57) ABSTRACT

A query expansion method that improves the precision without degrading the recall, uses augmented terms. The method steps expand an initial query by adding new terms that are related to each term of the initial query. The query is further expanded by adding augmented terms, which are conjunctions of the terms. A weight is assigned to each term so that the augmented terms have higher weights than the other terms.

### RELATED APPLICATION DATA

The instant application claims priority to Korean Patent Application No. 10-2008-0024776 filed Mar. 18, 2008.

### BACKGROUND OF THE INVENTION

1. Field of the Invention

Embodiments of the invention generally pertain to the field of computer-assisted information retrieval. More particularly, an embodiment of the invention is directed to a query expansion method that improves the precision of the query without degrading the recall by using new and augmented terms.

2. Description of the Related Art

As the amount of data on the Internet increases, search engines have become the main means for retrieving information on the Internet. Search engines receive a combination of terms (i.e., words) as a query from the user, and return documents relevant to the query as the result. The effectiveness of search engines is mainly evaluated by precision and recall. Precision measures the ability to retrieve relevant documents among the returned documents. Recall measures the ability to retrieve the most, or more, relevant documents among all the relevant documents.

It can be difficult to construct a query that completely represents the user's intention because the vocabulary of an automated information retrieval (IR) system may not mimic that of a human user. Thus the terms used in the query may not match those used in the documents that are stored in the various search engines (known in the art as the “mismatch problem.”). For example, suppose the user wants to retrieve documents related to “car”. The user's query may contain only the one term, “car.” However, documents containing the term “car” and/or the term “automobile” may be relevant to the car query. In this case, then, the search engine returns only those documents containing the term in the query (i.e., “car”). Thus the retrieved documents do not completely satisfy the user's intention. This mismatch problem generally reduces the precision and recall of the search engines.

A known extended Boolean model and query expansion method are described below.

### Extended Boolean Model

The extended Boolean model combines the retrieval model of the Boolean model and the ranking model of the vector space model as reported by Kwon, O. W., Kim, M. C., and Choi, K. S., “Query Expansion Using Domain Adapted, Weighted Thesaurus in an Extended Boolean Model,” Proc. 3rd Int'l Conf. on Information and Knowledge Management, pp. 140-146, Gaithersburg, Md., November 1994.

Briefly, in the Boolean model, documents are represented as the sets of terms. Queries consist of the terms connected by three logical operators: AND, OR and NOT. For a given query, the model retrieves documents that satisfy the Boolean expression of the query.

In the vector space model, documents and queries are represented as vectors in a multi-dimensional vector space. The terms of the model form the multi-dimensional vector space. Each term in a document and a query is given a weight. Weights of terms are commonly calculated by a “TF-IDF term weighting scheme” as reported by Baeza-Yates, R. and Ribeiro-Neto, B., Modem Information Retrieval, Addison Wesley, 1999. In the TF-IDF term weighting scheme, a term has more weight if it frequently occurs in one document (i.e., having a high term frequency) and rarely appears in the rest of the document collection (i.e., having a low inverse term frequency). Documents are ranked according to similarity of the documents to the query. Similarity is calculated by a “cosine similarity measure”, which is the cosine of the angle between two vectors. The cosine similarity of a document \vec{d} to a query \vec{q} is calculated as in Eq. (1) below.

$$similarity ( \vec{d} , \vec{q} ) = \frac{\vec{d} \cdot \vec{q}}{\vert \vec{d} \vert \cdot \vert \vec{q} \vert} \qquad ( 1 )$$

The cosine similarity is the inner product of the two vectors \vec{d} and \vec{q}. That is, the similarity is the sum of the weights of the query terms in the document.

The extended Boolean model lies somewhat in between the Boolean model and the vector space model. That is, the extended Boolean model supports the Boolean query and document ranking.

FIG. 1 shows a retrieval model based on the extended Boolean model. The extended Boolean model combines the retrieval model of the Boolean model with the ranking model of the vector space model. Thus all documents that satisfy the Boolean query are retrieved and those documents are then ranked by the cosine similarity measure.

For example, suppose that W_{A,q} and W_{B,q} are the weights of terms A and B in the query, respectively. Suppose further that W_{A,d} and W_{B,d} are the weights of terms A and B in the document, respectively. The similarity of the document to the query is calculated as in Eq. (2) for the two base cases (i.e., for the logical AND and OR operators). The similarity depends on the weights of terms in the document and in the query, as follows:

$$similarity ( d , {A}_{{W}_{A , q}} AND {B}_{{W}_{B , q}} ) = similarity ( d , {A}_{{W}_{A , q}} OR {B}_{{W}_{B , q}} ) \\ = \frac{{W}_{A , q} \cdot {W}_{A , d} + {W}_{B , q} \cdot {W}_{B , d}}{2} \qquad ( 2 )$$

Table 1 shows the information on an exemplary document collection. The document collection in this example contains two documents d₁ and d₂; d₁ contains two terms, ‘petrol’ and ‘car’; d₂ contains one term, ‘petrol’.

TABLE 1

Term

| Document (d) | Petrol | Car |
|---|---|---|
| d₁ | 0.4 | 0.3 |
| d₂ | 0.9 | 0.0 |

In the document d₁, the weights of the term “petrol” and “car” are 0.4 and 0.3, respectively. In the document d₂, the weight of the term “petrol” is 0.9. Consider the two queries: qₒᵣ=“car” OR “petrol,” q_{and}=“car” AND “petrol.” Suppose that the weight of “petrol” in qₒᵣ and q_{and} is 0.7 and the weight of “car” in qₒᵣ and q_{and} is 0.8. In the case of qₒᵣ, d₁ and d₂ are retrieved because those documents satisfy the Boolean expression of the query qₒᵣ. In case of q_{and}, only d₁ is retrieved. Using Eq. (1), the similarities are calculated as in Eqs. (3) and (4), below. Because similarity (d₂, qₒᵣ) is greater than similarity (d₁, qₒᵣ), the document d₂ will be ranked higher than the document d₁ in the case of qₒᵣ.

$$\begin{matrix}similarity ( {d}_{1} , {q}_{or} ) = similarity ( {d}_{1} , {q}_{ and} ) \\ = \frac{0.7 * 0.4 + 0.8 * 0.3}{2} = 0.26 & [ 3 ] \\ similarity ( {d}_{2} , {q}_{or} ) = \frac{0.7 * 0.9 + 0.8 * 0.0}{2} = 0.315 & [ 4 ]\end{matrix}$$

Other known, exemplary query expansion methods are described in below.

Kwon et al., id., proposed a thesaurus reconstructing method called Domain Adapted Weighted Thesaurus (DAWIT), for enriching domain dependent terms in a thesaurus and proposed a simple query expansion using the thesaurus. The DAWIT method expands the query by adding new terms, called ‘related terms’, that are related to each term of the query. The authors used a typical thesaurus for finding related terms. For example, the DAWIT method expands the query as in the following three steps: First, it finds related terms of each term in the query. Next, it replaces each term in the query with the disjunctions of the term and its related terms. Finally, it assigns a new weight to each term of the expanded query. However, the DAWIT method does not guarantee that a document containing more query terms is ranked higher than other documents.

Salton et al. proposed a query expansion approach using relevance feedback. The query expansion approach using relevance feedback selects terms from the recently retrieved documents for query expansion. It combines the terms using the logical AND and OR operators. This approach uses AND operators to expand the query. However, using relevance feedback does not guarantee that documents having more query terms are ranked higher than other documents; nor does it use the original terms in the query to expand the query.

In summary, query expansion methods generally reduce the precision of search engine results. For a query that uses logical disjunctions of terms, the query expansion approach in the extended Boolean model does not consider the user's preference, which may indicate that a user prefers documents that have more query terms therein.

### SUMMARY OF THE INVENTION

An embodiment of the present invention is a query expansion method using augmented terms. According to an aspect, the method expands a query of a user by adding new terms that are related to the query and, then, assigns weights to the respective, new terms. According to the embodied method, precision increases without degrading the recall.

According to an embodiment, a query expansion method consists of a) determining an original query; b) expanding the query by adding a related term to each term of the original query; c) further expanding the query by adding an augmented term to the expanded query, wherein an augmented term is a conjunction of the related terms; and d) assigning a weight to each term such that the augmented terms have higher weights than the other terms. In a non-limiting, exemplary aspect, step (b) comprises using the DAWIT algorithm to select related terms from an external thesaurus. In a non-limiting aspect of step (c), the documents in which query terms co-occur can be identified through the augmented terms. If a document contains augmented terms, the document will contain all of the singletons of the augmented terms.

In a non-limiting aspect of step (d), co-occurring terms are re-weighted on the basis of the user's preference. Thus a document containing more query terms will be ranked higher than a document having less query terms.

The features and advantages of the embodied invention will be more clearly understood from the following detailed description taken in conjunction with the accompanying drawings.

### BRIEF DESCRIPTION OF THE DRAWINGS

FIG. 1 is a flowchart that shows a query expansion method using augmented terms according to an embodiment of the invention;

FIG. 2A is an example listing that shows original terms and related terms of a query according to an illustrative aspect of the invention;

FIG. 2B is flowchart-type listing that shows a query expansion process using the terms of FIG. 2A according to an illustrative aspect of the invention; and

FIG. 3 is a flowchart that shows the details of the step of assigning weights to respective terms of an expanded query according to an illustrative aspect of the invention.

### DETAILED DESCRIPTION OF EMBODIMENTS OF THE INVENTION

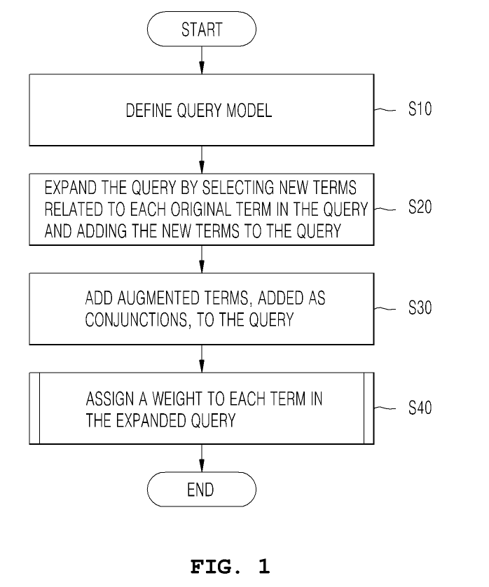

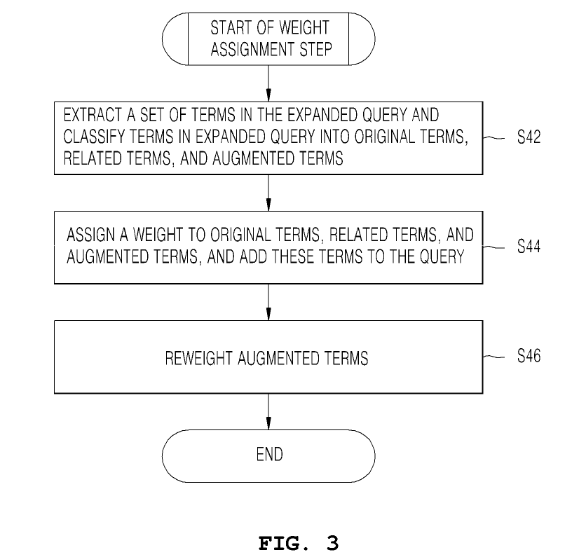

A representative query expansion method using augmented terms for improving precision without degrading recall according to an embodiment of the invention will be described with reference to FIGS. 1 and 3. FIG. 1 is a flowchart that shows a query expansion method using augmented terms. As shown in FIG. 1, the query expansion method includes four steps. Step S10 defines a query model; in other words, an initial query is determined. In step S20, the query is expanded by selecting new terms related to each original term in the query and adding the new terms to the query. In step S30, augmented terms are added as conjunctions to the query. In step S40, a weight is assigned to each term in the expanded query. Further details of steps S10-S40 are described as follows.

An initial query (query model) is determined in step S10. The initial query may be defined as a logical combination of terms using logical symbols such as, e.g., ‘AND’, ‘OR’, and ‘NOT’, but is not limited as such. In an illustrative aspect, one or more initial queries are considered as a logical disjunction of m terms (t₁, t₂, . . . , tₘ), as shown in Eq. (5):

q=t₁ [symbol] t₂ [symbol] . . . [symbol] tₘ (5)

Each term, t, is a singleton; i.e., a term tᵢ (1≦i≦m) is defined as an original term, and a query q is defined as an original query. The notation and terminology used in the following description are summarized in Table 2 below.

TABLE 2

| Symbol | Description |
|---|---|
| Q | the user's query (or the original query) |
| ExpandedQuery(q) | the expanded query of the query q |
| RelatedTerm(t) | the set of related terms of the term t |
| tᵢ | an original term in query |
| tᵢⱼ | a related term of the original term tᵢ |
| τ | an augmented term |
| W_{t, q} | the weight of the term t in the query q |

In step S20, the query is expanded by selecting new terms related to each original term of the query and adding the new terms to the query.

In detail, a term related to the term in the query is selected. For example, when an initial query is ‘petrol,’ the term ‘gasoline’ can be selected as a term related to the initial query. In another example, when an initial query is ‘car,’ the term ‘automobile’ may be selected as a term related to the initial query.

The original term tᵢ (1≦i≦m) in the query has pᵢ related terms t₁, t₂ , . . . , tₚᵢ. The set of related terms of each term tᵢ can be represented by RelatedTerm(tᵢ)={tᵢ_{₁}, tᵢ_{₂}, . . . , tᵢ_{ₚᵢ}}. The term tᵢ can be expanded to tᵢ [symbol] tᵢ_{₁} [symbol] tᵢ_{₂} [symbol] . . . [symbol] tᵢ_{ₚᵢ} and can be represented by

$${t}_{i} ⋁ ( {{⋁}^{{P}_{i}}}_{j = 1} {t}_{ij} ) .$$

That is, each term of the query is replaced with disjunctions of the original term and its related terms. Therefore, the query in Eq. (5) is expanded to the query in the following Eq. (6):

$$Expanded Query ( q ) = ( {t}_{1} ⋁ ( {{⋁}^{{P}_{1}}}_{j = 1} {t}_{1 j} ) ) ⋁ ( {t}_{2} ⋁ ( {{⋁}^{{P}_{2}}}_{j = 1} {t}_{2 j} ) ) ⋁ … ( {t}_{m} ⋁ ( {{⋁}^{{P}_{m}}}_{j = 1} {t}_{mj} ) ) \qquad ( 6 )$$

In this exemplary illustration, the selection of the related terms is based on the similarity between the original term and each related term. The similarity between terms is measured by the “Mutual Information” (MI) between two terms, x and y, as follows:

$$MI ( x , y ) = log \frac{\frac{number of ( x , y ) pairs in document collection}{total number}}{\frac{number of x}{total number} * \frac{number of y}{total number}}$$

The similarity and the MI are further explained below.

In step S30, the augmented terms, which are conjunction(s) of terms, are added to the query in Eq. (6) so as to reflect a user's preference.

It is recognized that users prefer a document with (n+1) query terms to that with n query terms. According to the user's preference, the co-occurrence of query terms in the documents has significance in the ranking of documents. According to an aspect, an ‘augmented term’ for expressing the co-occurrence of query terms is disclosed. The number of query terms contained in a document may also be important. The number of query terms contained in the document is denoted as the ‘co-ordination level’. Step S30 is explained in further detail through the definitions and examples described below.

Definition 1: Let q be a query that are disjunction(s) of terms. Let R be a set of the original terms and the related terms of the query q. Suppose that t is a term of the query q. A query aspect of the term t is defined as the subset of R containing the term t and the related terms of t.

Definition 2: Let q be a query that are disjunction(s) of terms. Let R be a set of the original terms and related terms of the query q. An augmented term τ is defined as conjunction(s) of terms in R. Here, each singleton in τ belongs to one distinct query aspect.

Definition 3: The augmented-term co-ordination level (‘at-co-ordination level’) of the augmented term τ is defined as the number of singletons in τ.

The following example uses the definitions 1, 2, and 3 above. Let the original query q=“petrol” or “car” or “sale.” The term “gasoline” is the related term of “petrol”; the term “automobile” is the related term of “car”; the term “selling” is the related term of “sale.” hat is, R={“petrol”, “car”, “sale”, “gasoline”, “automobile”, “selling”}. Thus there are three query aspects: the query aspect of “petrol” is {“petrol”, “gasoline”}, the query aspect of “car’ is {”car“, “automobile”}, and the query aspect of “sale” is {“sale”, “selling”}. Since (“petrol” and “car”) and (“petrol” and “automobile”) contain two singletons, they have an at-co-ordination level equal to 2. Further, since (“petrol” and “car” and “sale”) contains three singletons, it has an at-co-ordination level equal to 3. If “petrol” and “car” co-occur in a document d, it is regarded that the document d contains the augmented term (“petrol” and “car”).

According to an embodiment of the invention, documents in which query terms co-occur can be identified. Since augmented terms express the co-occurrence of query terms, the documents can be identified through the augmented terms. If a document contains an augmented term, the document also contains the singletons of the augmented term. In addition, one or more augmented terms can occur in a document. In order to represent the augmented terms as a query, the augmented terms of the given query q are combined through the disjunctive operator.

When it is assumed that there are l augmented terms τ₁, τ₂, . . . , τₗ, the query in Eq. (6) is expanded to the query in Eq. (7) below:

$${ExpandedQuery}_{Augmented} ( q ) = ( {t}_{1} ⋁ ( {{⋁}^{{P}_{1}}}_{j = 1} {t}_{1 j} ) ) ⋁ ( {t}_{2} ⋁ ( {{⋁}^{{P}_{2}}}_{j = 1} {t}_{2 j} ) ) ⋁ … ⋁ ( {t}_{m} ⋁ ( {{⋁}^{{P}_{m}}}_{j = 1} {t}_{mj} ) ) ⋁ ( {τ}_{1} ⋁ {τ}_{2} ⋁ … ⋁ {τ}_{1} ) \qquad ( 7 )$$

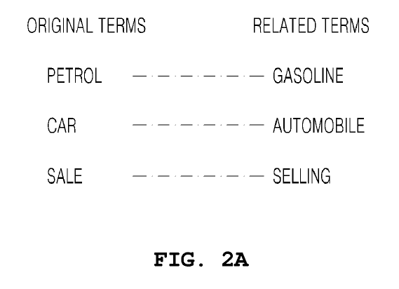

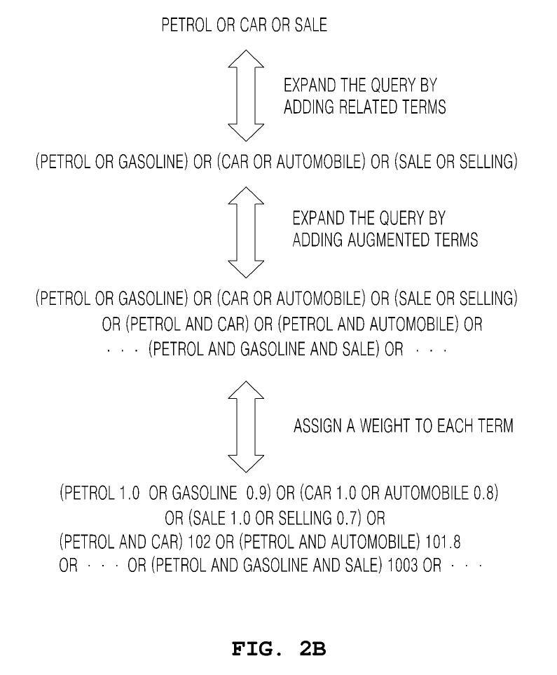

FIG. 2A shows an example of original terms and the related terms in a query, and FIG. 2B shows an example of expanding a query. The terms in the original query are “petrol”, “car”, and “sale”, and their related terms are added to the original query. That is, the query is expanded to (“petrol” OR “gasoline”) OR (“car” OR “automobile”) OR (“sale” OR “selling”). Further, the augmented terms (“gasoline”, “automobile”, “selling”) are added to the query. The query is expanded to [(“petrol” OR “gasoline”) OR (“car” OR “automobile”) OR (“sale” OR “selling”) OR (“petrol” AND “car”) OR (“petrol” AND “automobile”) OR . . . OR (“petrol” AND “car” AND “sale”) OR . . . ].

In step S40, a weight is assigned to each term of the expanded query using a co-occurrence aware term reweighting scheme. That is, with reference to FIG. 3, a set T of the terms of the expanded query is extracted, and the terms of the expanded query are classified into three types of terms—original terms, related terms and augmented terms, at step S42. Weights of the original terms, related terms and augmented terms are assigned in step S42; those terms are added to the query in step S44; and the augmented terms are reweighted in step S46.

The weight of each original term is assigned as 1.0, that of the related term is assigned as the similarity between the original term and the related term and, that of the augmented term is assigned as a weight according to its co-ordination level and similarity. The augmented terms always have weights greater than those of the original terms and the related terms.

In the illustrated, exemplary aspects of the invention, the weights of related terms are assigned by calculating the similarity to the original term, and the similarity is calculated using the Mutual Information (MI). It will be appreciated by those skilled in the art that the weights and the methods to assign the weights are not limited to the illustrated, exemplary aspects of the invention.

The mutual information (MI) between two terms x and y is obtained by measuring the information of x contained in y, and vice versa. That is, the value between two terms x and y is computed as by Eq. (8), and is normalized by log in the range of [0, 1].

$$MI ( x , y ) = log \frac{\frac{number of ( x , y ) pairs in document collection}{total number}}{\frac{number of x}{total number} * \frac{number of y}{total number}} \qquad ( 8 )$$

Here, “total number” represents the total number of terms in the document collection.

The steps for calculating the weight of each augmented term is described below. Consider an augmented term T. Then, |τ| is the at-co-ordination level of T. In order to assign a weight to the augmented term, according to a non-limiting, exemplary aspect, a monotonic function is selected for the at-co-ordination level. In addition, the weights of augmented terms having the at-co-ordination level (n+1) are always greater than those of augmented terms having the at-co-ordination level n.

In an exemplary aspect, a function used to calculate the weight of the augmented term is 10^{|τ}. For example, the function sets a value of 100 to the weight of an augmented term having the at-co-ordination level 2, and 1000 to that of an augmented term having the at-co-ordination level 3. Thereafter, in order to reweight the augmented term, the similarities of terms in the augmented term τ are used. The weight of the augmented term depends on the sum of the weights of the terms in it. The weight of an augmented term τ in a query q is calculated as per Eq. (9):

$${W}_{τ , q} = {10}^{\vert τ \vert} + {\sum }_{t ∈ τ} {W}_{t , q} \qquad ( 9 )$$

With reference to a portion of the expanded query described above with reference to FIG. 2B, the step S40 for assigning weights to each term in the expanded query is described in further detail as follows.

Consider an original query q; q=“petrol” OR “car” OR “sale”, and qₑₓₚ≡ExpanedQuery(q)=(“petrol” OR “gasoline”) OR (“car” OR “automobile”) OR (“sale” OR “selling”) OR (“petrol” OR “car”) OR (“petrol” AND “automobile”) OR . . . OR (“petrol” AND “car” AND “sale”) OR . . . .

The set T of terms in the expanded query can be represented as follows: T={“petrol”, “car”, “sale”, “gasoline”, “automobile”, “selling”, (“petrol” AND “car”), (“petrol” AND “automobile”), (“petrol” AND “car” AND “sale”), . . . }. That is, the original terms are “petrol”, “car”, and “sale”; related terms are “gasoline”, “automobile”, and “selling”; and, augmented terms are (“petrol” AND “car”), (“petrol” AND “automobile”), and (“petrol” AND “car” AND “sale”).

Thereafter, the weight of each term in the expanded query qₑₓₚ is computed. Since terms “petrol”, “car”, and “sale” are original terms, the weights of these terms are 1.0, and the weights of the related terms “gasoline”, “automobile”, and “selling” are computed to be 0.9, 0.8, and 0.7, respectively, as in Eq. (8).

The weights of augmented terms (“petrol” AND “car”), (“petrol” AND “automobile”) and (“petrol” AND “car” AND “sale”) are calculated to be 102, 101.8, and 1003, respectively, as in Eq. (9). The weight of the augmented term having the at-co-ordination level 3, i.e., (“petrol” AND “car” AND “sale”), is greater than that of the augmented term having the at-co-ordination level 2, i.e., (“petrol” AND “car”) and (“petrol” AND “automobile”). The weights of the original terms are greater than those of the related terms. Therefore, in the case of the augmented terms having the same at-co-ordination level, the weight of the augmented term (“petrol” AND “car”) is greater than that of the augmented term (“petrol” AND “automobile”). In the example, “car” is an original term, and “automobile” is a related term of “car.”

Experiments were performed in order to compare the effectiveness of the embodied query expansion using augmented terms with the query expansion approach using DAWIT. The results of the experiments using the TREC-6 (Voorhees, E. M. and Harman, D., “Overview of the Sixth Text Retrieval Conference (TREC-6),” In Proc. 6th Text Retrieval Conference, pp. 1-24, Gaithersburg, Md., Nov. 19-21, 1997) document collection showed that the query expansion using augmented terms outperformed the query expansion using DAWIT by up to 102% in precision and by up to 157% in recall for the top-10 retrieved documents.

Although the preferred embodiments of the present invention have been disclosed for illustrative purposes, those skilled in the art will appreciate that various modifications, additions and substitutions are possible, without departing from the scope and spirit of the invention as disclosed in the appended claims.

We claim:

1-7. (canceled)

8. A query expansion method, comprising the steps of:
determining an initial query;
expanding the initial query by selecting a new term that is related to each term in the initial query and adding the new term to the initial query;
further expanding the query by adding an augmented term that is a conjunction of terms to the query; and
assigning a weight to each term in the further expanded query.

9. The query expansion method according to claim 8, wherein the step of assigning a weight to each term in the further expanded query, further comprises:
extracting a set of terms in the expanded query, and classifying the terms of the expanded query into original terms, related terms, and augmented terms;
assigning weights to the original terms, the related terms, and the augmented terms and adding the weights to the query; and
reweighting the augmented terms.

10. The query expansion method according to claim 8, wherein the step of assigning a weight to each term in the further expanded query is performed such that the weights of the augmented terms having an at-co-ordination level (n+1) is always greater than those of augmented terms having an at-co-ordination level n.

11. The query expansion method according to claim 8, wherein the weight of each related term is assigned by calculating the similarity between the original term and the related term.

12. The query expansion method according to claim 11, wherein the similarity is measured by a Mutual Information (MI(x,y)) between the original term (x) and the related term (y), wherein
$$MI ( x , y ) = log \frac{\frac{number of ( x , y ) pairs in document collection}{total number}}{\frac{number of x}{total number} * \frac{number of y}{total number}}$$

13. The query expansion method according to claim 9, wherein the augmented terms always have weights greater than those of the original terms and the related terms.

14. The query expansion method according to claim 9, wherein the weight of the augmented term is determined by the value of a function of a co-ordination level of the augmented term and the summation of the weights of the original terms and the weights of the related terms in the augmented term.

15. The query expansion method according to claim 14, wherein the function of the co-ordination level of the augmented term is 10^{|τ|}, where |τ| is the co-ordination level of the augmented term.
